(19) United States
(12) Patent Application Publication
(10) Pub. No.: US 2010/0100601 A1
(43) Pub. Date: Apr. 22, 2010

(54) MEDIA CONTENT TRANSMISSION METHOD AND NETWORK-SIDE EQUIPMENT

(75) Inventor: Lei Zhu, Shenzhen (CN)

Correspondence Address: Huawei Technologies Co., Ltd.;c/o Darby & Darby P.C., P.O. Box 770, Church Street Station, New York, NY, 10008-0770, US

(73) Assignee: HUAWEI TECHNOLOGIES CO., LTD., Shenzhen (CN)

(21) Appl. No.: 12/644,367

(22) Filed: Dec. 22, 2009

Related U.S. Application Data
(63) Continuation of application No. PCT/CN2008/071243, filed on Jun. 10, 2008.

(30) Foreign Application Priority Data
Jun. 26, 2007 (CN) 200710112446.3

(51) Int. Cl. G06F 15/16

(52) U.S. Cl. 709/206; 709/227

(57) ABSTRACT

A media content transmission method disclosed herein includes: The network-side equipment receives a first message containing the media content, includes the received media content into a second message, and then transmits the second message. A network-side equipment is also provided herein.

### CROSS-REFERENCE TO RELATED APPLICATIONS

This application is a continuation of International Application No. PCT/CN2008/071243, filed on Jun. 10, 2008, which claims priority to Chinese Patent Application No. 200710112446.3, filed on Jun. 26, 2007, both of which are hereby incorporated by reference in their entireties.

### FIELD OF THE INVENTION

The present invention relates to the wireless communication field, and in particular, to a method and a network-side equipment for transmitting media content based on a cellular system.

### BACKGROUND

A user generally includes media into the header or message body of a Session Initiation Protocol (SIP) message, for example, a text, an audio, a video clip, or a media index such as Uniform Resource Locator (URL). Therefore, the user receiving the SIP message can obtain the included media from the message or through the network.

A solution to the pre-establishment of a session is provided in the prior art. In this solution, the connection between the client and some functions of the network is pre-established. When a user needs to initiate a session for communicating with another user or needs to receive a request from another user, the user can send or receive a session request through the pre-established connection. The prior art shortens the time of creating a session, and enables direct exchange of the session message with the network.

The prior art has at least the following defects:

The media content contained in the session request in the prior art is terminated at the network side where a session is pre-established. Therefore, no signaling is available for bearing the media content before pre-establishment of the session. This causes that the media content cannot be sent to the client through the pre-established session, and thus the media content is unavailable to common users if the session is pre-established.

### SUMMARY

The embodiments of the present invention provide a method for transmitting media content. The method enables the sending of media content to a client if a session is pre-established.

The embodiments of the present invention provide a network-side equipment which enables the sending of received media content to the client if a session is pre-established.

A media content transmission method provided in an embodiment of the present invention includes:

receiving a first message containing media content;

including the media content contained in the first message into a second message; and

sending the second message.

A media content transmission method provided in another embodiment of the present invention includes:

receiving, a message of subscribing to a state of media content;

obtaining a message containing media content according to the state of media content; and

sending the message containing the media content.

A media content transmission method provided in another embodiment of the present invention includes:

receiving, a message containing, referenced media content or text content; generating a user-plane message, including the referenced media content or text content into the user-plane message; and

sending the user-plane message.

A network-side equipment provided in an embodiment of the present invention includes:

a receiving unit, adapted to receive a first message containing media content; and

an embedding unit, adapted to; include the media content contained in the first message into a second message, and send the second message.

A network-side equipment provided in another embodiment of the present invention includes:

a first receiving unit, adapted to receive a message of subscribing to a state of media content; and

an obtaining unit, adapted to: obtain a message containing the media content according to the state of media content, and send the message containing the media content.

A network-side equipment provided in another embodiment of the present invention includes:

a second receiving unit, adapted to receive a message containing referenced media content or text content; and

a generating unit, adapted to: generate a user-plane message, include the referenced media content or text content; into the user-plane message, and send the user-plane message.

A technical solution under the present invention brings the following benefits:

A client that initiates a session sends a message containing the media content to a network-side equipment; and the network-side equipment includes the media content into a subsequent message for transmitting. By contrast, in the prior art, the media content contained in the session request is terminated at the network side where a session is pre-established. In the embodiments of the present invention, however, the media content is included into a message and sent to the client, and therefore, the media content is available to common users if a session is pre-established.

Another technical solution under the present invention brings the following benefits: After receiving the message of subscribing to the state of media content, the network-side equipment may obtain the message containing the media content according to the subscribed state of media content, and then send the message containing the media content. In this way, the media content corresponding to the state of media content is sent to the client through a message if a session is pre-established, and the media content is available to common users if a session is pre-established.

Another technical solution under the present invention brings the following benefits: After receiving a message containing referenced media content or text content, the network-side equipment may generate a user-plane message containing the referenced media content or text content, and then transmit the user-plane message. In this way, the referenced media content or text content may be sent to the client through a message if a session is pre-established, and the media content is available to common users if a session is pre-established.

### BRIEF DESCRIPTION OF THE DRAWINGS

FIG. 1 is a flowchart of a media content transmission method in a first embodiment of the present invention;

FIG. 2 is a flowchart of a media content, transmission method in a second embodiment of the present invention;

FIG. 3 is a flowchart of a media content transmission method in a third embodiment of the present invention;

FIG. 4 is a flowchart of a media content transmission method in a fourth embodiment of the present invention;

FIG. 5A-5B is a flowchart of a media content transmission method in a fifth embodiment of the present invention;

FIG. (is a flowchart of a media content transmission method in a sixth embodiment of the present invention;

FIG. 7 is a flowchart of a media content transmission method in a seventh embodiment of the present invention;

FIG. 8 is as flowchart of a media content transmission method in an eighth embodiment of the present invention;

FIG. 9 is a flowchart of a media content transmission method in a ninth embodiment of the present invention;

FIG. 10 is a flowchart of a media content transmission method in a tenth embodiment of the present invention;

FIG. 11 shows a network-side equipment in an eleventh embodiment of the present invention;

FIG. 12 shows a network-side equipment in a twelfth embodiment of the present invention; and

FIG. 13 shows a network-side equipment in a thirteenth embodiment of the present invention.

### DETAILED DESCRIPTION

In the prior art, the media content in a SIP message is not transmittable to as client when the SIP message containing the media content is terminated in the network. The embodiments of the present invention provide a method for transmitting the media content to the client in such circumstances. The method includes: pre-establishing a SIP signaling used in the session, and including the received media content into the SIP signaling; and sending the media content to the client through a notification message other than the pre-established session signaling. The notification message may be a user-plane message, a control-plane SIP message, or a SIP notification. The notification message may be a Participating Function (PF) notification or a Controlling Function (CF) notification if such a notification is subscribed to by the user.

To make the embodiments of the present invention clearer, the following describes the embodiments of the present invention in more detail with reference to the accompanying drawings.

### Embodiment 1

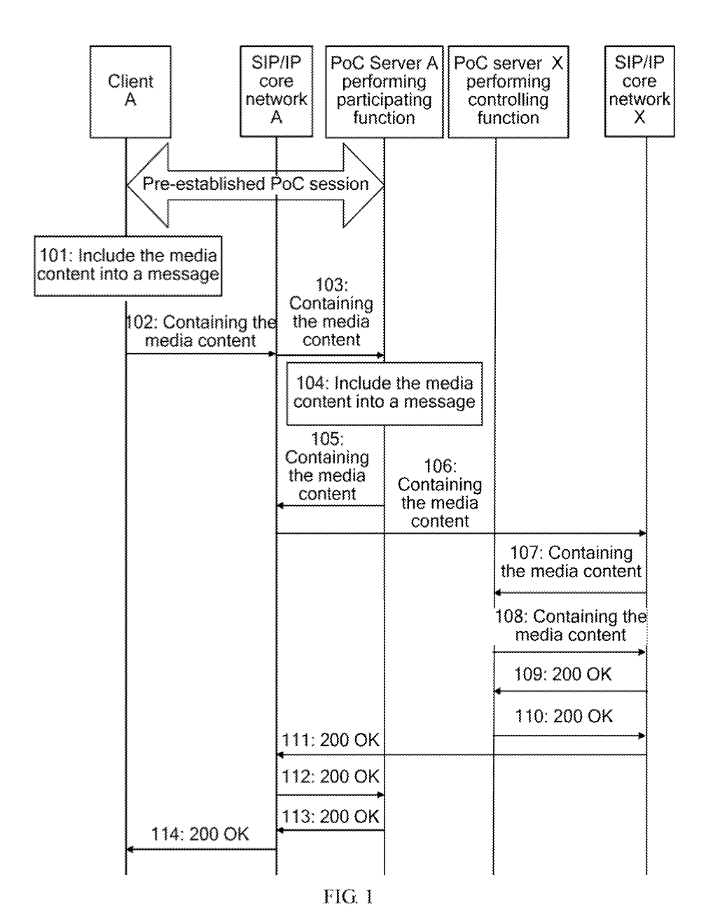

A media content transmission method is provided in this embodiment. A calling party A uses a client A which has pre-established a session connection with a Push to Talk over Cellular (PoC) server A. The Open Mobile Alliance (OMA) PoC specifications stipulate that in a pre-established PoC session, a call is initiated through a SIP REFER message. After receiving the SIP REFER message, the participant PoC server (basically equivalent to the home server with respect to meanings and functions) includes the service information contained in the SIP REFER message into a newly generated SIP INVITE message for further transmission, where the participant PoC server is on the network where the PoC user initiating a call resides As shown in FIG. 1, the steps are as follows:

Step 101: The client A generates a SIP REFER message, and includes the media content into the SIP REFER message.

Step 102: The client A sends the SIP REFER message containing the media content to the SIP/IP core network A.

Step 103: The SIP/IP core network A forwards the SIP REFER message to a home PoC Server A performing participating function of the client A.

Step 104: According to the normal process, the PoC Server A performing participating function generates a SIP INVITE message, and includes the media content contained in the SIP REFER message into the SIP INVITE message.

Step 105: The PoC Server A performing participating function sends a SIP INVITE message to the SIP/IP core network A.

Steps 106-108: The SIP/IP core network A forwards the SIP INVITE message to the PoC Server X performing controlling function through the SIP/IP core network X. The PoC Server X performing controlling, function sends the SIP INVITE message to the SIP/IP core network X, and the SIP/IP core network X forwards the SIP INVITE message to the called party network.

Step 109: The called party network generates and returns an acknowledgment (200 OK) message to the PoC Server X performing controlling function through the SIP/IP core network X.

Step 110: The PoC Server X performing controlling function sends a 200 OK response to the SIP/IP core network X.

Steps 111-112: The SIP/IP core network X sends the 200 OK response to the PoC Server A performing participating function through the SIP/IP core network A.

Steps 113-114: The PoC Server A performing participating function sends the 200 OK response to the client A through the SIP/IP core network A.

In the method for a client to send media content in this embodiment, the SIP message used in the pre-established session is not only used to carry media content to be received by the client using pre-established session, but also used to send or receive the media content. In addition, the message used for pre-establishing a session in this embodiment is not hunted to a SIP signaling message, and may be a Real-time Transport Protocol (RIP) message or Message Session Relay Protocol (MSRP) message, or any extension of the protocol message such as extended SIP INVITE message, extended SIP REFER message, extended SIP MESSAGE, extended SIP PUBLISH message, extended SIP OPTION message, extended SIP INFO message, extended SIP 2xx response message, and extended SIP 1xx response message.

### Embodiment 2

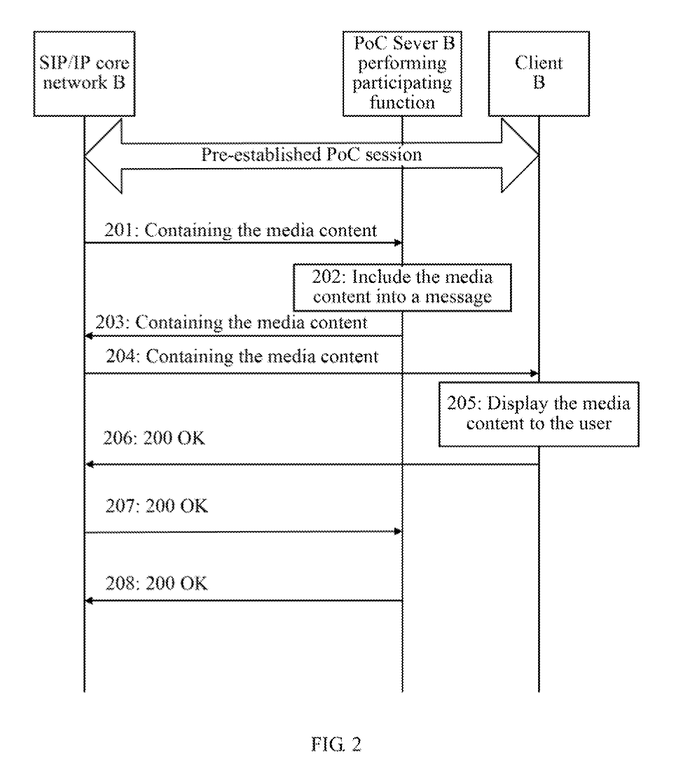

A media content transmission method is disclosed in this embodiment. In this embodiment, a session is pre-established between the client B used by the called party B and the PoC server B. The PoC Server B performing participating function includes the media content into the SIP message already used in the pre-established session. As shown in FIG. 2, the steps are as follows:

Step 201: The SIP/IP core network B sends the received SIP INVITE message to the PoC Server B performing, participating function. The SIP INVITE message contains the media content.

Step 202: In this scenario, if the client B decides to receive the SIP INVITE message in manual response mode, the PoC Server B performing participating, function generates a new SIP INVITE message, and includes the media content contained in the old SIP INVITE message into the generated SIP INVITE message.

Steps 203-204: The PoC Server B performing participating function sends a SIP INVITE message to the SIP/IP core network B, and the SIP/IP core network 13 forwards the SIP INVITE message to the client B.

Step 205: After receiving the SIP INVITE message, the client B displays the media content to the called party B.

Steps 206-208: The client B generates a 200 OK response, and sends the 200 OK response to the SIP/IP core network B. The SIP/IP core network B forwards the 200 OK response to the PoC Server B performing participating function.

In the two embodiments above, the network-side equipment receives a SIP message containing media content, and includes the media content into another SIP message newly generated. The two SIP messages may be of the same or different types. The SIP messages that may carry media content include: SIP INVITE message, SIP REFER message, SIP MESSAGE, SIP PUBLISH message, SIP OPTION message, SIP INFO message, SIP 2xx response message, and SIP 1xx response message. The client used by the called party B in this embodiment uses a manual response mode. In the following embodiment, if the client of the called party B uses an Automatic Answer Mode, the OMA PoC specifications stipulate that the home server of the called party needs to send a notification message (such as a Connect message) to the user after receiving the SIP INVITE message containing the media content.

### Embodiment 3

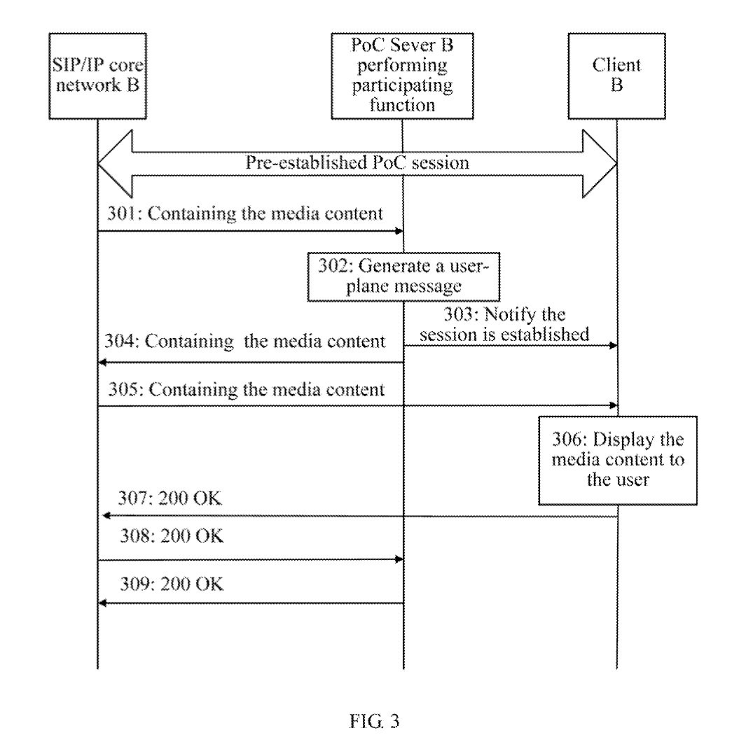

A media content transmission method is provided in this embodiment. As shown in FIG. 3, the method includes the following steps:

Step 301: The SIP/IP core network B that covers the called party B receives a SIP INVITE message containing media content and forwards the SIP INVITE message to the PoC Server B performing participating function.

Steps 302-303: The PoC Server B performing participating function generates a user-plane message, and, as stipulated in the OMA PoC specifications, sends the user-plane message to the client B, notifying that the session is established. The user-plane message may be a notification message which is extended according to the RTP/Real-time Transport Control Protocol (RTCP), for example, a Connect message, or may be a Talk Burst Control Protocol (TBCP) message.

Steps 304-305: The user-plane message in this embodiment is not suitable for carrying media content. Therefore, after receiving the media content contained in the SIP INVITE message, the PoC Server B performing participating function generates a new SIP message, and includes the media content into the new SIP message and sends the new SIP message to the client B.

Step 306: After receiving the SIP INVITE message, the client B displays the media content to the called party B.

Steps 307-309: The client B generates a 200 OK response, and sends the 200 OK response to the SIP/IP core network B. The SIP/IP core network B forwards the 200 OK response to the PoC Server B performing participating function.

In this embodiment, a session is pre-established, and the received message is processed in the Automatic Answer Mode. In this case, the client using pre-established session in the Automatic Answer Mode may send a non-SIP message containing the relevant service information to a client, and may receive a user-plane message from a client.

In addition, if the user sets as manual response mode, this embodiment can also be well used without using the message existing in the pre-established session to carry the media content.

### Embodiment 4

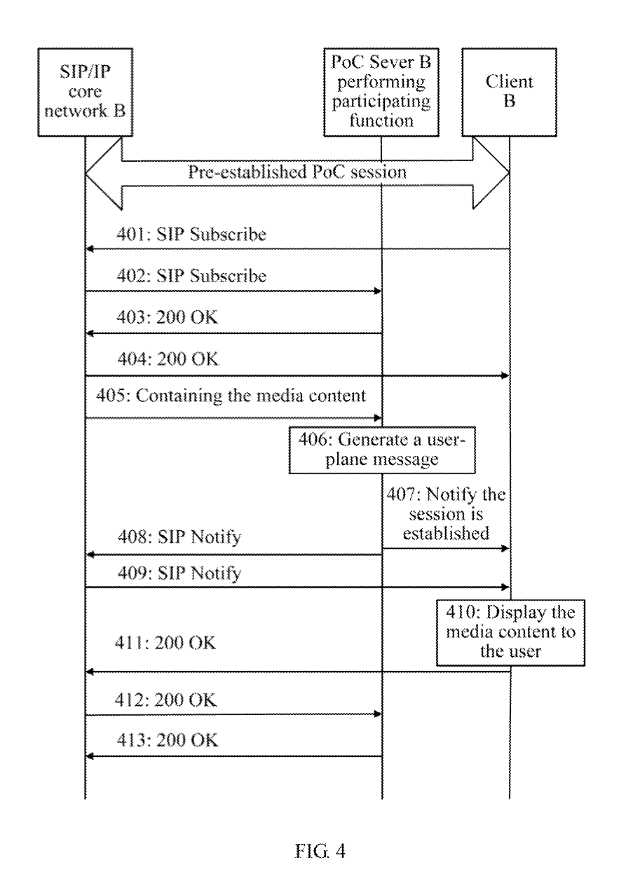

A media content transmission method is provided in this embodiment. In this embodiment, the media content is sent through a state notification. As shown in FIG. 4, the method includes the following steps:

Steps 401-402: The client B sends a SIP Subscribe message to the PoC Server B performing participating function through a SIP/IP core network B, with a view to subscribing to the state change that occurs on the PoC Server B performing participating function. The SIP Subscribe message contains a state of the required media content.

In addition, the service information in the message used in a pre-established session may carry the state of the required media content. In this case, no SIP Subscribe message needs to be sent.

Steps 403-404: The PoC Server B performing participating function sends a 200 OK response to the client B through the SWAP core network.

Step 405: The SIP/IP core network B that covers the called party B receives a SIP INVITE message containing media content, and forwards the SIP INVITE message to the PoC Server B performing participating function.

Steps 406-407: The PoC Server B pert brining participating, function generates a user-plane message (such as Connect message), and, according to the OMA PoC specifications, sends the user-plane message to the client B, notifying that the session is established.

Steps 408-409: The PoC Server B performing participating function receives the media content contained in the SIP INVITE message. Because the client B has subscribed to the state information of the media content from the PoC Server B performing participating function, the PoC Server B performing participating function sends a state notification message (that is, a SIP Notify message) to the client B, and includes the media content into the SIP Notify message.

Step 410: After receiving the SIP Notify message, the client B displays the media content to user B.

Steps 411-413: The client B generates a 200 OK response, and sends the 200 OK response to the SIP/IP core network B. The SIP/IP core network B forwards the 200 OK response to the PoC Server B performing participating function. The PoC Server B performing participating function sends the 200 OK response to the called party B through the SIP/IP core network B.

This embodiment is intended for the subscription/notification mechanism on the home server. In the fourth embodiment, a session is pre-established between the client B and the PoC Server B performing participating function which is home to user B. Because the PoC Server B performing participating function is unable to send the media content to the client B directly, the PoC Server B performing participating function generates a new SIP Notify message, and includes the media content into the SIP Notify message and sends the message to the client B.

According to the requirements of the SIP Subscribe/Notify mechanism, the client B generally needs to subscribe to the notification. If the SIP message used in the pre-established session contains a flag indicative of subscription to the relevant information, the flag is a substitute for the SIP Subscribe message. In this case, a SIP Notify message containing media content is enough in the process.

### Embodiment 5

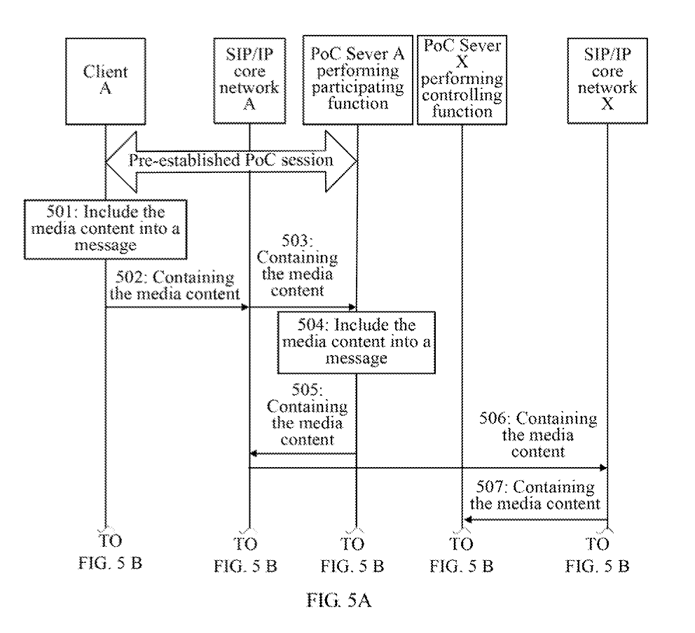

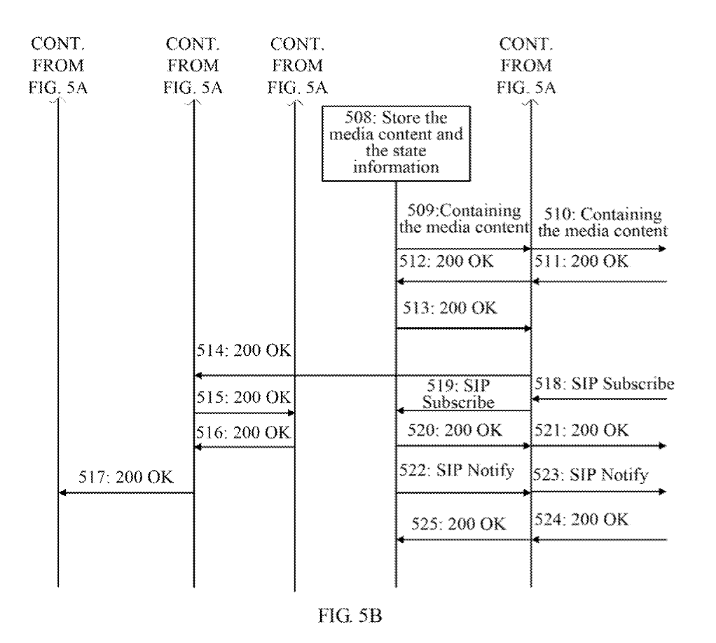

A media content transmission method is provided in this embodiment. As shown in FIG. 5A-5B, the method includes the following steps:

Step 501: The client A generates a SIP REFER message, and includes a certain type of media content into the SIP REFER message.

Steps 502-503: The client A sends the SIP REFER message containing the media content to the SIP/IP core network A. The SIP/IP core network A forwards the SIP REFER message to a home PoC Server A performing participating function of the client A.

Step 504: According to the normal process, the home PoC Server A performing, participating function of the client A generates a SIP INVITE message, and includes the media content contained in the SIP REFER message into the SIP INVITE message.

Steps 505-507: The home PoC Server A performing participating function of the client A sends a SIP INVITE message to the SIP/IP core network A, and the SIP/IP core network A forwards the SIP INVITE message to the PoC Server X performing controlling, function through the SIP/IP core network X.

Step 508: The PoC Server X performing controlling function stores the media content contained in the SIP INVITE message, namely, stores the media content as part of the state information into the PoC Server X performing controlling function.

Steps 509-510: The PoC Server X performing controlling function sends the SIP INVITE message to the SIP/IP core network X. The SIP/IP core network X forwards the SIP INVITE message to the called, party network. At this time, the SIP INVITE, message contains no media content.

Steps 511-517: The called party network sends a 200 OK response to the PoC Server X performing controlling function through the SIP/IP core network X. The PoC Server X performing controlling function sends the 200 OK response to the PoC Server A performing participating function through the SIP/IP core network X and the SIP/IP core network A. The PoC Server A performing participating function forwards the 200 OK response to the client A through the SIP/IP core network A.

Steps 518-519: The SIP/IP core network X receives the SIP Subscribe message from the client B, and forwards the message to the PoC Server X performing controlling function.

Steps 520-521: The PoC Server X performing controlling function sends the 200 OK response to the SIP/IP core network X. The SWAP core network X forwards the 200 OK response to the called party network.

Steps 522-523: The PoC Server X performing controlling function generates a SIP Notify message, and includes the media content into the SIP Notify message. The PoC Server X performing controlling function forwards the SIP Notify message to the SIP/IP core network X, and the SIP/IP core network X forwards the SIP Notify message to the called party network.

Steps 524-525: The SWAP core network X receives the 200 OK response from the client B, and forwards the response to the PoC Server X performing controlling function.

In this embodiment, the media content is sent to the called party network through a session state notification process, where the process is on a centralized control server at the calling network side. A session is pre-established between the client A and the home PoC Server A performing participating function of the client A, and the client A includes the media content into a SUP REFER message, and originates a call to other called parties.

### Embodiment 6

A media content transmission method is provided in this embodiment. As shown in FIG. 6, the method includes the following steps:

Steps 601-602: After the SIP/IP core network B that covers the called party B receives the SIP INVITE message, the media content is stored as state information by the centralized control server that controls the session. At this time, the SIP INVITE message contains no media content. The SIP/IP core network B forwards the SIP INVITE message to the PoC Server B performing participating function.

Steps 603-604: The PoC Server B performing participating function generates a user-plane message (such as Connect message), and, according to the OMA PoC specifications, sends the user-plane message to the client B, notifying that the session is established.

Steps 605-607: The client B sends a SIP Subscribe message to the SIP/IP core network B, with a view to subscribing to the session state information stored on the centralized control server, including the state of the required media content. The SIP/IP core network B sends the SIP Subscribe message to the PoC Server B performing participating function. The PoC Server B performing participating function forwards the SIP Subscribe message to the controlling function of the PoC server at the calling network side.

Steps 608-611: The SIP/IP core network B receives the SIP Notify message containing the media content, and sends the message to the PoC Server B performing participating function. The PoC Server B performing participating function sends the SIP Notify message to the client B through the SIP/IP core network B.

Step 612: After receiving the SIP Notify message, the client B displays the media content to user B.

Steps 613-616: The client B generates a 200 OK response, and sends the 200 OK response to the SIP/IP core network B. The SIP/IP core network B forwards the 200 OK response to the PoC Server B performing participating, function. The PoC Server B performing participating function sends the 200 OK response to the called party B through the SIP/IP core network B.

The media content may be sent to the user in diversified formats. For example, the media content of a text format may be text contents transmitted in the message body of the SIP message; and the media content of a multimedia format (such as pictures, videos, voice files) may be transmitted in the message body of a SIP message. The media content may be referenced, for example, through a URL in the message, thus becoming referenced media content.

The transmission of the media content contained as text content or referenced media content in a SIP message is described in the following embodiment. In the following embodiment, the user-plane message may be a Connect message, Talk Burst request, or Talk Burst taken message.

### Embodiment 7

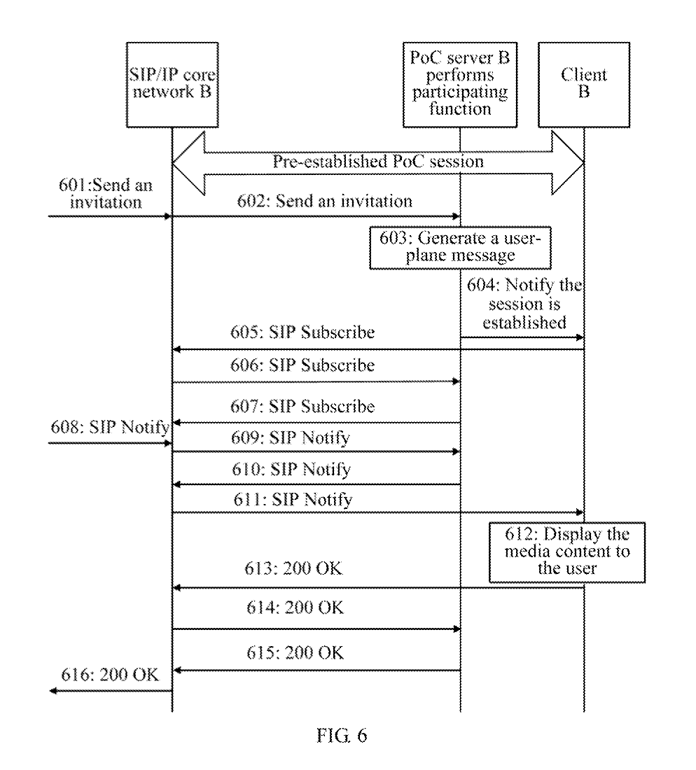

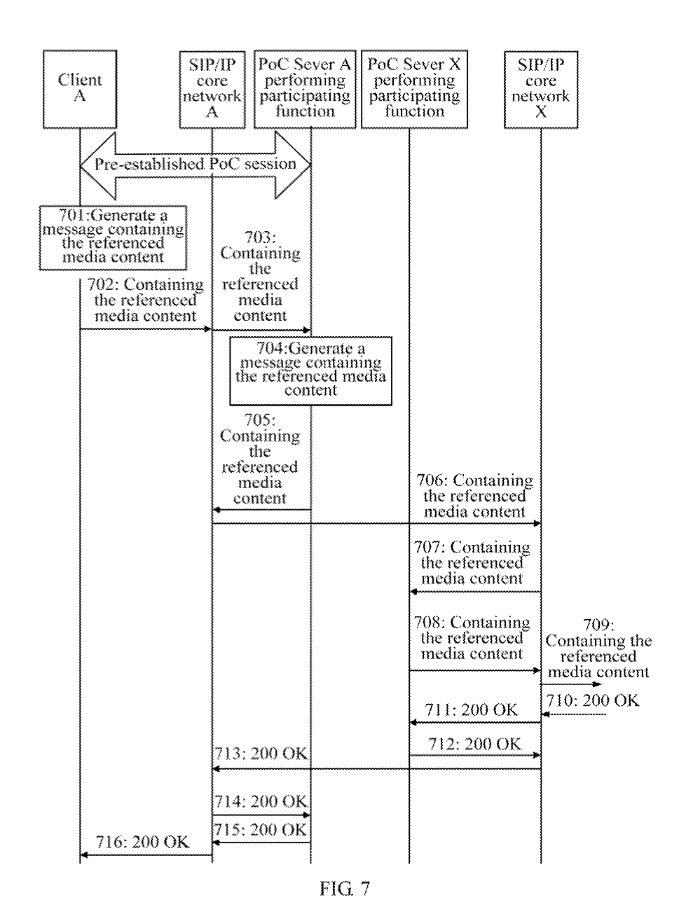

A media content transmission method is provided in this embodiment. As shown in FIG. 7, the method includes the following steps:

Step 701: If a session is pre-established between the calling client A and the home server, the calling client generates a SIP REFER message for initiating setup of a session. The SIP REFER message carries referenced media content.

If no session is pre-established between the calling user and the home server, the calling client generates another message such as SIP INVITE for initiating setup of a session. The use of other SIP messages is similar.

Step 702: The client A sends the SIP REFER message containing the referenced media content to the SIP/IP network.

Step 703: The SIP/IP network forwards the SIP REFER message containing the referenced media content to the home PoC server A of the client A.

Step 704: The home PoC server A of the client A receives the SIP REFER message that caries the referenced media content, and generates a SIP INVITE message and includes the referenced media content into the SIP INVITE message.

Steps 705-707: The home PoC server A of the client A may send the SIP INVITE message containing the referenced media content to the SIP/IP network, and the PoC server X that controls the session is located in the SIP/IP network. The SIP/IP network routes the SIP INVITE message containing the referenced media content to the PoC server X that controls the session.

Steps 708-710: The PoC server X that controls the session sends the SIP INVITE message containing the referenced media content to the SIP/IP network that covers the called client B.

Steps 711-712: The SIP/IP network that covers the called client B routes the message to the SIP/IP network that covers the PoC server X, and a 200 OK response is sent to the PoC server X.

Steps 713-716: The PoC server X returns a 200 OK response to the client A. The 200 OK response is sent to the client A through the SIP/IP network and the home PoC server A of the client A.

### Embodiment 8

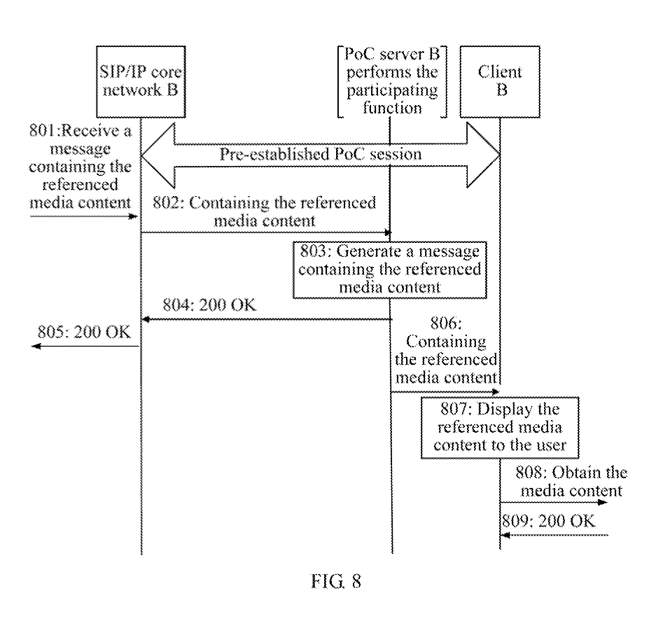

A media content transmission method is provided in this embodiment. In this embodiment, a session is pre-established between the client B and the home PoC server B, and an Automatic Answer Mode is set on the client B. As shown in FIG. 8, the method includes the following steps:

Steps 801-802: The home PoC server B of the called client B receives the SIP INVITE message containing the referenced media content.

Step 803: The PoC server B generates a user-plane message such as Connect message. The Connect message carries the referenced media content in the text format, for example, http://location.MediaContent.domain.

If the media content is already in the text format, the media content in the text format may be included in the Connect message. In addition, if the referenced media content is included in the Connect message, a field in the Connect message or a newly included flag bit may indicate the purposes of the included text content.

Steps 804-805: Because an Automatic Answer Mode is set on the client B, the PoC server B returns a 200 OK response to the PoC server X. The 200 OK response is routed by the network to the SIP/IP network that covers the PoC server X.

Step 806: The PoC server B sends the Connect message containing the referenced media content to the client B.

Step 807: The client B displays the referenced media content to user B.

If the Connect message contains text content, the text content is displayed to user B.

Step 808: According to the selection of user B, the client B may send a request of obtaining the media content.

Step 809: The entity providing the media content returns a response. In this way, the client B obtains the media content through a reference to the media content.

The eight embodiments described above are based on the PoC service. In addition, the present invention is also applicable to the scenario where the media content is not transmissible to the client, as exemplified in the following two embodiments.

### Embodiment 9

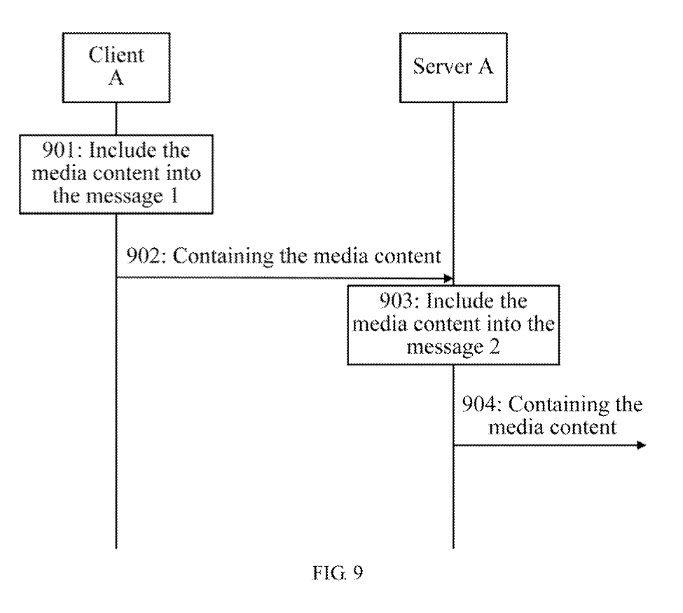

A media content transmission method is provided in this embodiment. As shown in FIG. 9, the method includes the following steps:

Step 901: The client A generates a message 1, and includes the media content into the message 1. The message 1 is any message that can carry the media content.

Step 902: The client A sends the message 1 containing the media content to the home server A of the client A.

Step 903: The server A includes the media content into a message 2. The message 2 is any message that can carry the media content.

Step 904: The server A sends the message 2 containing the media content to the network that covers the called party; and therefore, the called party can obtain the media content from the network.

### Embodiment 10

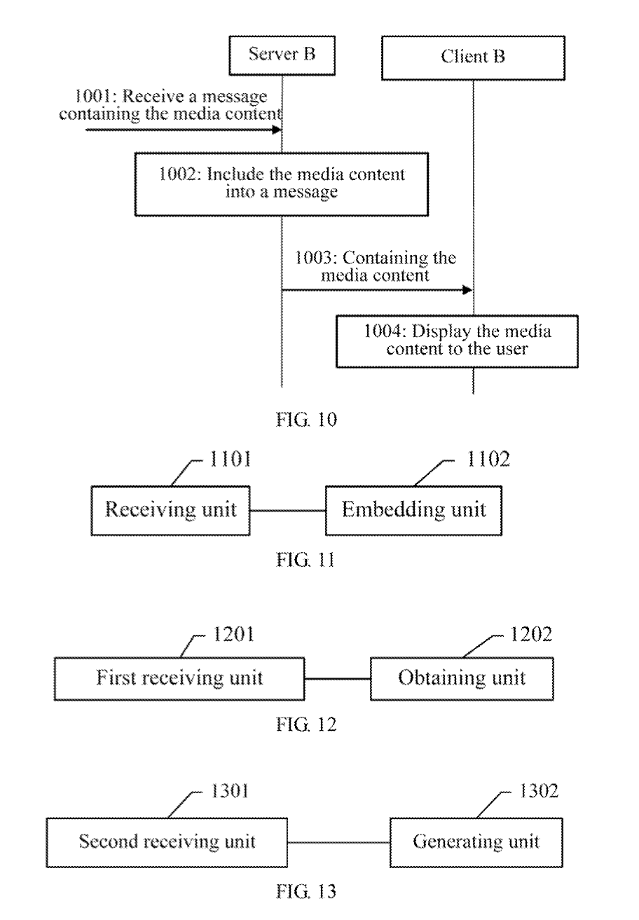

A media content transmission method is provided in this embodiment. As shown in FIG. 10, the method includes the following steps:

Step 1001: The server B that covers the client B receives a message containing the media content. The message may be any message that can carry the media content.

Step 1002: The server B generates a new message, and includes the media content contained in the old message into this new message.

Step 1003: The server B sends the message containing the media content to the client B.

Step 1004: After receiving the message, the client B displays the media content to user B.

In the 10 embodiments described above, the received message containing the media content may be sent from the client or from another network-side equipment.

In addition, the network may send the message containing the media content to the client, or to another network-side equipment.

It is understandable to those skilled in the art that all or part of the steps of the preceding embodiments may be implemented by hardware instructed by a program. The program may be stored in a computer-readable storage medium. When being executed, the program performs the following steps:

The network-side equipment receives a first message containing the media content, includes the received media content into a second message, and then sends the second message.

Optionally, the steps executed by the program may be:

receiving a message of subscribing to a state of media content; and

by a network-side equipment, obtaining the message containing the media content according to the state of media content, and sending the message containing the media content.

The storage medium may be a Read Only Memory (ROM/Random Access Memory (RAM), magnetic disk or Compact Disk (CD).

### Embodiment 11

A network-side equipment is disclosed in this embodiment. As shown in FIG. 11, the network-side equipment includes:

a receiving unit 1101, adapted to receive a message containing the media content; and

an embedding unit 1102, adapted to: include the received media content into a second message, and send the second message with the included media content.

In this embodiment, the type of the first message may be the same as or different from the type of the second message. The messages that can carry the media content include: SIP INVITE message, SIP REFER message, SIP MESSAGE, SIP PUBLISH message, SIP OPTION message, SIP INFO message, SIP 2xx response message, and SIP 1xx response message. In addition, the embedding unit may send the message with included media content to the client or another network-side equipment.

### Embodiment 12

A network-side equipment is disclosed in this embodiment. As shown in FIG. 12, the network-side equipment includes:

a first receiving unit 1201, adapted to receive a message of subscribing to a state of media content; and

an obtaining unit 1202, adapted to: obtain the message containing the media content according to the state of media content, and send the message containing the media content.

### Embodiment 13

A network-side equipment is disclosed in this embodiment. As shown in FIG. 13, the network-side equipment includes:

a second receiving unit 1301, adapted to receive a message containing referenced media content or text content; and

a generating unit 1302, adapted to: generate a user-plane message, include the referenced media content or text content into the user-plane message, and send the user-plane message.

In addition, the network-side equipment is implemented not only through the embodiment 11 and the embodiment 13, but also through software or hardware modules of the same or equivalent functions.

In conclusion, the client that initiates the session sends a message containing the media content to a network-side equipment; and the network-side equipment includes the media content into a subsequent message for transmitting to the client or another network-side equipment. By contrast, in the prior art, the media content included in the session request is terminated at the network side where a session is pre-established. In the embodiments of the present invention, the media content is included into a message and sent to the client, and therefore, the media content is available to common users if a session is pre-established.

Another technical solution under the present invention brings the following benefits: After receiving a message of subscribing to the state of media content, the network-side equipment may obtain the message containing the media content according to the subscribed state of media content, and send the message. In this way, the media content corresponding to the state of media content may be sent to the client through a message if a session is pre-established, and the media content is available to common users if a session is pre-established.

Another technical solution under the present invention brings the following benefits: After receiving a message containing referenced media content or text content, the network-side equipment may generate a user-plane message that contains the referenced media content or text content, and then send the user-plane message. In this way, the referenced media content or text content may be sent to the client through a message if a session is pre-established, and the media content is available to common users if a session is pre-established.

Finally, the client that initiates the session includes the media content into a message and sends the message to a network-side equipment; and the network-side equipment includes the media content into a subsequent message for transmitting to the client. By contrast, in the prior art, the media content included in the session request is terminated at the network side where a session is pre-established. In the embodiments of the present invention, the media content is included into a message and sent to the client, and therefore, the media content is available to common users if a session is pre-established.

It is understandable to those skilled in the art that all or part of the steps of the foregoing embodiments may be implemented by hardware instructed by a computer program. The program may be stored in a computer-readable storage medium. When being executed, the program performs all or part of the steps in foregoing method embodiments.

All functional units in the embodiments of the present invention may be integrated into a processing module, or exist independently, or two or more of such units are integrated into a module. The integrated module may be hardware or a software module. When being implemented as a software module and sold or applied as an independent product, the integrated module may also be stored in a computer-readable storage medium.

The storage medium may be a Read-Only Memory (ROM), magnetic disk or Compact Disk (CD).

Elaborated above are a media content transmission method and a network-side equipment under the present invention. Although the invention is described through some exemplary embodiments, the invention is not limited to such embodiments. It is apparent that those skilled in the art can make modifications and variations to the invention without departing from the scope of the invention. The invention is intended to cover the modifications and variations provided that they fall in the scope of protection defined by the following claims or their equivalents.

What is claimed is:

1. A method for transmitting media content, comprising:
receiving a first message containing media content;
including the media content contained in the first message into a second message, and
sending the second message.

2. The method of claim 1, before including media content brought in the first message into the second message, further comprising:
generating the second message which is used to carry the media content.

3. The method of claim 1, before including media content brought in the first message into the second message, further comprising:
generating a user-plane message;
sending the user-plane message to a client to inform that a session has been established.

4. The method of claim 1, before receiving the first message containing media content, further comprising:
receiving Session Initiation Protocol (SIP) Subscribe message containing a state of required media content.

5. The method of claim 1, wherein the second message including the media content is any one of the following:
SIP message;
Real-time Transport Protocol (RIP) message;
Real-time Transport Control Protocol (RTCP) message;
Message Session Relay Protocol (MSRP) message; and
extended protocol message.

6. The method of claim 1, wherein the format of the media content is text format or multimedia format.

7. The method of claim 1, further comprising: initiating a session using a pre-established session between a client and a Push to Talk over Cellular (PoC) sever, before the PoC server receives the first message containing media content.

8. The method of claim 7, wherein:
the first message is received by the PoC server from the client through a SIP/IP core network; and
the second message is sent by the PoC server to a called party network.

9. The method of claim 8, wherein the first message is a SIP REFER message; and the second message is a SIP INVITE message.

10. The method of claim 7, wherein:
the first message is received by the PoC server from a SIP/IP core network; and
the second message is sent by the PoC server to the client through the SIP/IP core network.

11. The method of claim 10, wherein the first message is a SIP INVITE message; and
the second message is a SIP INVITE message.

12. A method for transmitting media content, comprising:
receiving a message containing referenced media content or text content;
generating a user-plane message, and including the referenced media content or text content into the user-plane message; and
sending the user-plane message.

13. The method of claim 12, further comprising: initiating a session using a pre-established session between a PoC sever and a client before the PoC server receives the message containing referenced media content or text content.

14. The method of claim 13, wherein:
the message containing referenced media content or text content is received by the PoC sever from a SIP/IP core network; and
the user-plane message is sent by the PoC sever to the client through the SIP/IP core network.

15. The method of claim 14, wherein after performing the step of sending the user-plane message by the PoC sever to the client through the SIP/IP core network, further comprising:
obtaining the media content by the client according to referred media content.

16. The method of claim 13, wherein the message containing referenced media content or text content is a SIP message.

17. The method of claim 13, wherein the user-plane message is generated according to RTP, RTCP, or Talk Burst Control Protocol (TBCP).

18. A network-side equipment, comprising:
a receiving unit, adapted to receive a first message containing media content; and
an embedding unit, adapted to: include the media content contained in the first message into a second message, and send the second message.

19. The network-side equipment of claim 18, wherein the network-side equipment is a PoC server.
